(19) United States
(12) Patent Application Publication
(10) Pub. No.: US 2008/0126878 A1
(43) Pub. Date: May 29, 2008

(54) HIGHLIGHTING ANOMALIES WHEN DISPLAYING TRACE RESULTS

(75) Inventors: Steven F. Best, Georgetown, TX (US); Robert J. Eggers, Austin, TX (US); Janice M. Girouard, Austin, TX (US); Barbara E. Wang, Austin, TX (US)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/563,807

(22) Filed: Nov. 28, 2006

(51) Int. Cl. G06F 11/32

(52) U.S. Cl. 714/45; 714/E11.181

(57) ABSTRACT

A computer program product and method for displaying trace log entries from a plurality of trace logs call for identifying trace log entries; determining a degree of relevancy for each of the trace log entries; and classifying the trace log entries.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to debugging software.

2. Description of the Related Art

Software developers and customer support representatives are often tasked with debugging software programs. As one skilled in the art realizes, debugging the software programs can be a challenging task.

One approach to debugging software involves logging errors, anomalies and events as the software programs run. The errors, anomalies and events are logged to hard files or stored temporarily in memory. As one can imagine, a software program with many lines of code can have an overwhelming amount of errors, anomalies and events logged. General attempts to keep the logged information at manageable levels have focused on schemes to limit the information logged.

For example, Linux limits the information logged through “printk” statements. The first parameter of the printk statement controls the information logged. Separate categories are maintained for errors, anomalies and events such as “information,” “notice,” “warning,” error, “critical error”, “alert,” and “emergency.” The user sets the level for logging errors, anomalies, and events they wish to view. The level is set to an appropriate mark to manage the size of the disk log. For example, the user can choose to see all errors that are in the category “error” up to and including “emergency.” Generally, the size of the disk log is managed not due to the cost of disk space, but due to the need to avoid a flood of information that exceeds what a developer is able to handle.

There are problems with schemes to control the amount of information logged such as the one for Linux. Often the information required to debug a problem is discarded because the level is set too high. Merely lowering the level to KERN_DEBUG in Linux, for example, is not an acceptable solution because processing the output is manual and prohibitively time consuming.

What are needed are software and hardware that logs all errors, anomalies and events and yet focuses the developer's attention on the relevant information.

### SUMMARY OF THE INVENTION

The shortcomings of the prior art are overcome and additional advantages are provided through the provision of a computer program product stored on machine readable media including machine readable instructions for displaying trace log entries from a plurality of trace logs, the instructions include instructions for identifying the trace log entries; determining a degree of relevancy for each of the trace log entries; and classifying the trace log entries.

Also disclosed is a computer system including a computer program product having instructions for displaying trace log entries from a plurality of trace log entries, the product includes instructions for receiving instructions for identifying the trace log entries; identifying static portions of the trace log entries; receiving instructions for determining the degree of relevancy; determining the degree of relevancy using a relevancy ratio determined from one of a ratio of a percentage of occurrence for each trace log entry for a first trace log to the percentage of occurrence for the same trace log entry for a plurality of other trace logs; a ratio of the percentage of occurrence of each trace log entry in each trace log to the percentage of occurrence of the same trace log entry in at least one adjacent trace log; and an adjusted relevancy ratio; identifying preferences where the preferences are at least one of an input and a default; highlighting the trace log entries with a selected color correlated to the degree of relevancy; alerting a user to trace log entries that exceed a degree of relevancy threshold; and using the trace log entries as markers to identify a window.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### Technical Effects

As a result of the summarized invention, technically we have achieved a solution in which a computer program product stored on machine readable media includes machine readable instructions for displaying trace log entries from a plurality of trace logs, the instructions include instructions for identifying the trace log entries; determining a degree of relevancy for each of the trace log entries; and classifying the trace log entries.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts aspects of a computing infrastructure for implementation of the teachings herein;

FIG. 2 depicts aspects of one exemplary embodiment of a displaying method; and

FIG. 3 illustrates an exemplary method for displaying relevant trace log entries.

The detailed description explains the preferred embodiments of the invention, together with advantages and features, by way of example with reference to the drawings.

### DETAILED DESCRIPTION OF THE INVENTION

The teachings herein provide techniques for focusing a user's attention on relevant information used to debug computer programs. The techniques provide users with a degree of relevancy for errors, anomalies and events. The techniques also provide for classifying the entries based upon the degree of relevancy. Prior to discussing the techniques in more detail, certain definitions are provided.

The term “debugging” relates to a process of finding and reducing the number of “bugs” or defects in a computer program. The term “trace log entries” relates to entries of information such as errors, anomalies and events. Trace log entries can be used to analyze what was occurring before, during, and after the defects are encountered. The term “trace log” relates to a group of trace log entries that result from a computer run. The trace logs are typically logged to a hard disk or temporarily stored in memory. The term “diff” relates to a display tool that presents two or more trace logs of the same program (but different runs) in a side-by-side display. In a “diff” output, two trace logs that are displayed side-by-side are referred to as “adjacent.” The term “window” relates to portions of the trace logs that are displayed.

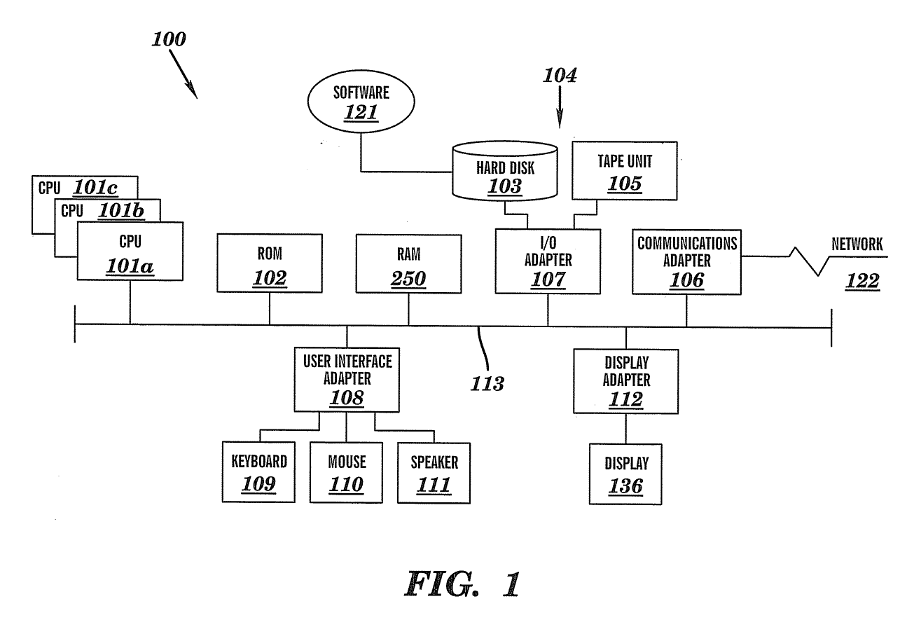

Referring now to FIG. 1, an embodiment of a computer processing system 100 for implementing the teachings herein is depicted. System 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 250 and various other components via a system bus 113. Read only memory (ROM) 102 is coupled to the system bus 113 and may include a basic input/output system (BIOS), which controls certain basic functions of system 100.

FIG. 1 further depicts an I/O adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. The network adapter 106 interconnects bus 113 with a network 122 enabling data processing system 100 to communicate with other such systems. The network 122 can be a local-area network (LAN), a metro-area network (MAN), or wide-area network (WAN), such as the Internet or World Wide Web. Display monitor 136 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

As disclosed herein, the system 100 includes machine readable instructions stored on machine readable media (for example, the hard disk 103) for classifying trace logs based upon the degree of relevancy. As disclosed herein, the instructions are referred to as “classifying method software 121.” Typically, the classifying method software 121 includes instructions for determining the degree of relevancy for each trace log entry identified in trace logs. The classifying method software 121 may also include instructions for classifying the trace log entries. The classifying method software 121 may be produced using software development tools as are known in the art. The classifying method software 121 may be provided as an “add-in” to an application (where “add-in” is taken to mean supplemental program code as is known in the art). In such embodiments, the classifying method software 121 replaces or supplements structures of the application for displaying trace log entries.

Thus, as configured FIG. 1, the system 100 includes processing means in the form of processors 101, storage means including system memory 250 and mass storage 104, input means such as keyboard 109 and mouse 110, and output means including speaker 111 and display 136. In one embodiment a portion of system memory 250 and mass storage 104 collectively store an operating system such as the AIX® operating system from IBM Corporation to coordinate the functions of the various components shown in FIG. 1.

It will be appreciated that the system 100 can be any suitable computer, Windows-based terminal, wireless device, information appliance, RISC Power PC, X-device, workstation, mini-computer, mainframe computer, cell phone, personal digital assistant (PDA) or other computing device.

Examples of other operating systems supported by the system 100 include versions of Windows, Macintosh, Java, LINUX, and UNIX, or other suitable operating systems.

Users of the system 100 can connect to the network 122 through any suitable connection, such as standard telephone lines, digital subscriber line, LAN or WAN links (e.g., T1, T3), broadband connections (Frame Relay, ATM), and wireless connections (e.g., 802.11 (a), 802.11 (b), 802.11 (g)).

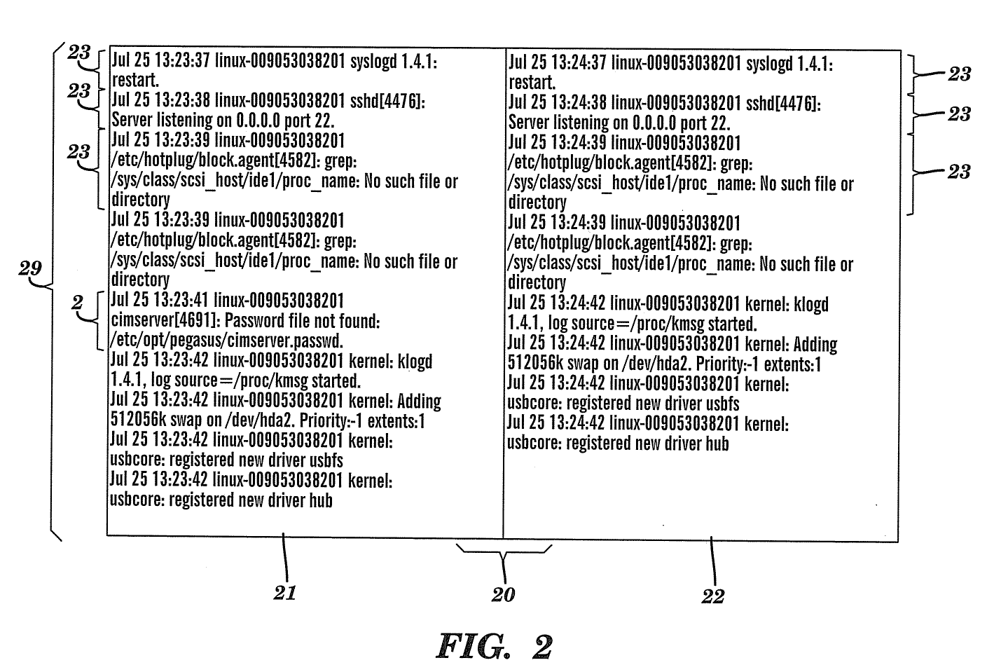

FIG. 2 depicts aspects of one exemplary embodiment of the classifying method software 121 for implementing the teaching herein. As shown in FIG. 2, a window 29 displays a “diff” output 20. The “diff” output 20 includes two trace logs. The two trace logs are the result of running the same computer program twice. The “diff” output 20 includes a first trace log 21 and a second trace log 22. The first trace log 21 and the second trace log 22 include a plurality of trace log entries 23. The second trace log 22 was logged approximately one minute after the first trace log 21 was logged. A relevant trace log entry 24 is the only difference between the first trace log 21 and the second trace log 22.

The relevant trace log entry 24 may be classified according to relevance of the errors, anomalies and events in the relevant trace log entry 24. For the illustrative example in FIG. 2, the relevant trace log entry 24 has more relevance than the plurality trace log entries 23. Classifying may include highlighting the relevant trace log entry 24 with a selected color such as red for example. With classifying, the user can readily focus on the relevant trace log entry 24 within the plurality of trace log entries 23. Other techniques as known in the art may be used to classify the relevant trace log entry 24 such as different color backgrounds and blinking text for example.

The teachings call for determining the degree of relevancy of each trace log entry 23 logged in the first trace log 21 and the second trace log 23. Part of determining the degree of relevancy is a process of uniquely identifying each trace log entry 23. The process includes identifying only static portions of each trace log entry. Dynamic portions are excluded because the dynamic portions typically contain addresses that are likely to be randomly assigned from run to run. These addresses are not important in determining the relevance of the trace log entries. Only the static portions of the trace log entries hold a statistical interest in determining relevance. For example, consider the trace log entry “tcpip allocating new socket 75 at memaddr 0x70004607.” The dynamic portions of this line are “75” and “0x70004607.” The static portions of the line are represented by “tcpip allocating new socket % d at memaddr % x.” Only the static portions of trace log entries are identified for purposes of determining the degree of relevancy. Statistical interest lies in treating trace log entries as identical if their static portions are identical.

Linux and AIX have a capacity to uniquely identify each trace log entry. The capacity includes identifying the trace log entry based on the entry's “static” printk format that is passed as the first parameter of printk. Referring to FIG. 2, the printk for the relevant trace log entry 24 is—printk(KERN_WARN “Password file not found: % s\n”, the_password_file). This printk may be present in the source code. The static portion of the message is “Password file not found: % s\n”. The dynamic portion of the message is “the_password_file”.

An exemplary method of accomplishing the identification process includes logging the file, directory, and line number of each trace log entry and associating this information with each trace log entry. With this information the static portions of the trace log entries can be identified.

With each trace log entry identified, the degree of relevancy may be determined for each trace log entry. The degree of relevancy is a measure of importance of each trace log entry to the debugging process. A statistical analysis is typically employed to determine the degree of relevancy.

On a simplistic level, a first step of the statistical analysis includes running the computer program twice. The first step produces two trace logs, the first trace log 21 and the second trace log 22. The statistical analysis counts the number of times each trace log entry appears in each trace log. A percentage of occurrence of each trace log entry is determined. The percentage of occurrence is determined by dividing the number of occurrences of the trace log entry by the total number of trace log entries.

A ratio of the percentage of occurrence of one trace log entry in the first trace log 21 to the percentage occurrence of the same entry in the second trace log 22 is determined. The ratio may be used as the degree of relevancy. The ratio is referred to as the “relevancy ratio.” Typically, the degree of relevancy is a normalized value ranging from zero to one, with one being “normal” and zero being “abnormal.” It is presumed that of the two runs, one is a successful run and one is a failing run. An illustrative example for determining the degree of relevancy follows.

Assume there are two computer runs of the same program. The two computer runs produce the first trace log 21 and the second trace log 22. One run is a successful run and the other run is a failing run. Also assume that the trace log entry 23, “hub 3-0:1.0: USB hub found”, occurs four times in the first trace log 21 and four times in the second trace log 22. Further assume the first trace log 21 and the second trace log 22 each contain 100 entries. The percentage of occurrence of the trace log entry 23 in each trace log is four percent. The ratio of the two percentages of occurrence is one. The degree of relevancy of one represents a “normal” event being logged. That is to say that the entry has a low degree of relevancy with respect to debugging the computer program.

If, on the other hand, the trace log entry 23 occurs four times in the first trace log 21 and zero times in the second trace log 22, then the ratio of the percentages of occurrence is 4%/0%. Because division by zero is undefined and because the teachings provide for the degree of relevancy to be normalized, the percentage of occurrence used in the denominator will be one of equal to and greater than the percentage of occurrence used in the numerator. For the illustrative example, the relevancy ratio is inverted to 0%/4% or zero. The degree of relevancy of zero represents an “abnormal” event. The “abnormal” event has a high degree of relevancy with respect to debugging the computer program.

Some embodiments provide for classifying the display of abnormal entries. One exemplary classifying technique is highlighting. The highlighting technique displays normal trace log entries in black with a color space display parameter (0,0,0). Abnormal entries are displayed in red with the color space display parameter (255,0,0). Entries with a degree of relevancy between zero and one are displayed in red in accordance with the color space display parameter [(1-degree of relevancy)*255, 0, 0]. Of course, one skilled in the art will recognize that any combination of colors or other such attributes may be used to provide for highlighting.

Because interest lies in abnormal entries when debugging computer programs, it may be advantageous to “amplify” the trace log entries with degrees of relevancy close to zero. Amplifying may be accomplished using the base 10 logarithm [where f(n)=log10(n)]. The base 10 logarithm has the property of amplifying f(n) value changes for values of n near 0 and minimizing f(n) value changes for values of n near 1. Furthermore, the base 10 logarithm has the property of being −1.0 when the argument is 0.1 and being 2.0 when the argument is 100. Therefore, the base 10 logarithm ranges from −1.0 to 2.0 when the argument ranges from 0.1 to 100. An adjusted relevancy ratio amplifies the relevancy ratio determined above. The adjusted relevancy ratio may be used as the degree of relevancy.

The adjusted relevancy ratio may be determined by various formulas. In one example, the adjusted relevancy ratio=[maximum ([log10 (relevancy ratio*100)], −1)+1]/3. Multiplying the relevancy ratio by 100 expands the range of the relevancy ratio from 0 to 1 to 0 to 100. Selecting from the maximum of log10(relevancy ratio*100) and −1 keeps the resulting value between −1 and 2. Adding one (+1) to the maximum insures that the resulting value will be positive (between 0 and 3). Finally, dividing by three (/3) insures that the adjusted relevancy ratio will be less than or equal to one.

When displaying three or more trace logs (N>2, where N=the number of trace logs displayed), the teachings call for using at least one of two techniques to determine the relevancy ratio. A first technique calls for determining the ratio of the percentage of occurrence of each trace log entry for each trace log 2 thru N to the percentage of occurrence of the same trace log entry for trace log 1.

A second technique calls for determining the ratio of the percentage of occurrence of each trace log entry for each trace log to the percentage of occurrence of the same trace log entry for at least one adjacent trace log. For example, the relevancy ratio is determined for each trace log entry of trace log 1 by determining the ratio of the percentage of occurrence of the trace log entry to the percentage of occurrence of the same trace log entry occurring in trace log 2. Similarly the relevancy ratio is determined for each trace log entry of trace log N−1 by determining the ratio of the percentage occurrence of the trace log entries for trace log N−1 to the percentage of occurrence of trace log entries for trace log N.

The teachings call for the classifying method software 121 to receive instructions for using other methods for determining the degree of relevancy. With respect to the teachings herein, the use of the degree of relevancy includes at least one of the use of the relevancy ratio, the adjusted relevancy ratio and other methods as may be input for determining the degree of relevancy.

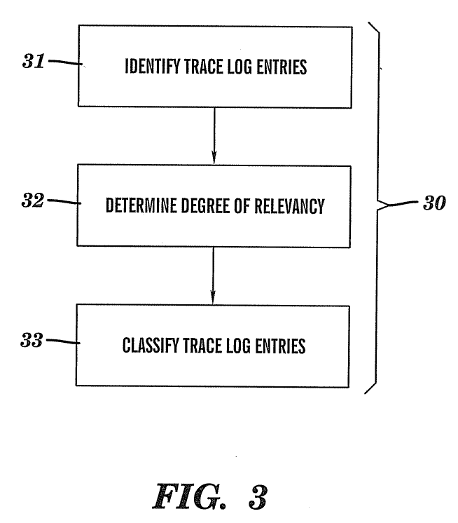

FIG. 3 illustrates an exemplary method 30 for classifying trace log entries. A first step 31 calls for identifying trace log entries. The first step 31 includes the process of recognizing the static portions of the trace log entries. The first step 31 may also include receiving instructions for identifying different portions of the trace log entries.

A second step 32 calls for determining the degree of relevancy. The second step 32 may include receiving instructions for determining the degree of relevancy. The second step 32 may also include determining the degree of relevancy using at least one of the relevancy ratio, the adjusted relevancy ratio and other methods as may be input.

A third step 33 calls for classifying the trace log entries. In general, the classifying is correlated to the degree of relevancy. Typically, classifying the trace log entries is accomplished by highlighting with a selected color. In one embodiment, the color displayed correlates to the degree of relevancy. The third step 33 may include receiving instructions for classifying the trace log entries. The instructions may include preferences such as the selected color and other highlighting details. The preferences may be input by at least one of the keyboard 109, the mouse 110, and the network 121. The teachings call for the use of default preferences if no preferences are input. The instructions may also include a degree of relevancy threshold. The third step 33 may include alerting the user to the trace log entries that exceed the degree of relevancy threshold.

The teachings also call for using trace log entries as “markers” to identify a window in the “diff” output 20 display. The markers identify at least one of a beginning, middle, and end of the window the user selects to display the “diff” output 20. For example, Linux systems typically boot with the “beginning marker” entry “syslogd 1.4.1: restart.” This trace log entry is the first entry in both the first trace log 21 and the second trace log 22. The beginning marker entry also may be used as an “end marker” by specifying “syslogd 1.4.1: restart” minus one message. The end marker entry identifies the last message in the “diff” output 20. The end marker entry is generally used if running a code section that failed at erratic times.

A “middle marker” identifies the trace log entry to focus the display on, surrounded by a selected number, N, of entries before and after the middle marker entry. For example, the entry “linux-009053038201 kernel: klogd 1.4.1, log source /proc/kmsg started.” appears in the “diff” output 20. The user may identify the trace log entry “log source=/proc/kmsg started.” as the middle marker. If this entry appears multiple times in the trace logs, then this entry along with N entries above and below are displayed for each appearance.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer program product stored on machine readable media comprising machine readable instructions for displaying trace log entries from a plurality of trace logs, the instructions comprising instructions for:
identifying the trace log entries;
determining a degree of relevancy for each of the trace log entries; and
classifying the trace log entries.

2. The computer program product as in claim 1, further comprising receiving instructions for identifying the trace log entries.

3. The computer program product as in claim 1, further comprising identifying static portions of the trace log entries.

4. The computer program product as in claim 1, further comprising receiving instructions for determining the degree of relevancy.

5. The computer program product as in claim 1, further comprising at least one of a relevancy ratio and an adjusted relevancy ratio.

6. The computer program product as in claim 1, further comprising determining a relevancy ratio by determining a ratio of a percentage of occurrence for each trace log entry from a first trace log to the percentage of occurrence for the same trace log entry from a plurality of other trace logs.

7. The computer program product as in claim 6, further comprising determining an adjusted relevancy ratio.

8. The computer program product as in claim 1, further comprising determining a relevancy ratio by determining a ratio of a percentage of occurrence for each trace log entry in each trace log to the percentage of occurrence for the same trace log entry in at least one adjacent trace log.

9. The computer program product as in claim 8, further comprising determining an adjusted relevancy ratio.

10. The computer program product as in claim 1, further comprising identifying preferences where the preferences are at least one of an input and a default.

11. The computer program product as in claim 1, further comprising highlighting the trace log entries with a selected color correlated to the degree of relevancy.

12. The computer program product as in claim 1, further comprising alerting a user to trace log entries that exceed a degree of relevancy threshold.

13. The computer program product as in claim 1, further comprising using the trace log entries as markers to identify a window.

14. The computer program product as in claim 1, wherein the product is an add-in.

15. A computer system comprising a computer program product having instructions for displaying trace log entries from a plurality of trace logs, the product comprising instructions for:
receiving instructions for identifying the trace log entries;
identifying static portions of the trace log entries;
receiving instructions for determining the degree of relevancy;
determining the degree of relevancy using a relevancy ratio determined from one of a ratio of a percentage of occurrence for each trace log entry for a first trace log to the percentage of occurrence for the same trace log entry for a plurality of other trace logs; a ratio of the percentage of occurrence of each trace log entry in each trace log to the percentage of occurrence of the same trace log entry in at least one adjacent trace log; and an adjusted relevancy ratio;
identifying preferences where the preferences are at least one of an input and a default;
highlighting the trace log entries with a selected color correlated to the degree of relevancy;
alerting a user to trace log entries that exceed a degree of relevancy threshold; and
using the trace log entries as markers to identify a window.
